(19) United States
(12) Patent Application Publication
(10) Pub. No.: US 2024/0284390 A1
(43) Pub. Date: Aug. 22, 2024

(54) POSITIONING METHOD AND APPARATUS, AND RELATED DEVICE

(71) Applicant: VIVO MOBILE COMMUNICATION CO., LTD., Dongguan (CN)

(72) Inventors: Ye SI, Dongguan (CN); Huaming WU, Dongguan (CN); Yuanyuan WANG, Dongguan (CN); Xiang PAN, Dongguan (CN)

(73) Assignee: VIVO MOBILE COMMUNICATION CO., LTD., Dongguan (CN)

(21) Appl. No.: 18/650,074

(22) Filed: Apr. 29, 2024

Related U.S. Application Data
(63) Continuation of application No. PCT/CN2022/129058, filed on Nov. 1, 2022.

(30) Foreign Application Priority Data
Nov. 3, 2021 (CN) 202111296492.X

(51) Int. Cl. H04W 64/00; G01S 5/00; H04L 5/00

(52) U.S. Cl. CPC H04W 64/00; G01S 5/0009; H04L 5/0048

(57) ABSTRACT

A positioning method and apparatus, and a related device are provided. The method includes: obtaining first target information by a first network device, and initiating a positioning procedure based on the first target information by the first network device. The positioning procedure includes at least one of the following: sending at least one of a Measurement Gap (MG) configuration or MG activation information to a second network device or a terminal; sending a Positioning Reference Signal (PRS) processing window configuration to the second network device or the terminal; or sending target indication information to the second network device or the terminal. The target indication information indicates information related to PRS measurement of the terminal.

### CROSS-REFERENCE TO RELATED APPLICATION

This application is a continuation of International Application No. PCT/CN2022/129058, filed on Nov. 1, 2022, which claims priority to Chinese Patent Application No. 202111296492.X, filed on Nov. 3, 2021. The entire contents of each of the above-referenced applications are expressly incorporated herein by reference.

### TECHNICAL FIELD

This application pertains to the field of communication technologies, and specifically relates to a positioning method and apparatus, and a related device.

### BACKGROUND

In the prior art, a downlink Positioning Reference Signal (PRS) based on a New Radio (NR) system is redesigned for terminals to perform positioning measurement. To complete positioning, the terminals need to measure PRSs sent by a plurality of cells. The terminals may measure a PRS sent by a non-serving cell. Considering possible asynchronicity between the non-serving cell and a serving cell, a current positioning manner of the terminals may cause a problem that positioning performance of terminals is poor.

### SUMMARY

Embodiments of this application provide a positioning method and apparatus, and a related device.

According to a first aspect, a positioning method is provided. The method includes the following steps.

A first network device obtains first target information.

The first network device initiates a positioning procedure based on the first target information.

The positioning procedure includes at least one of the following:
sending target indication information to a second network device and/or a terminal, where the target indication information indicates information related to positioning reference signal PRS measurement of the terminal;
sending at least one of a Measurement Gap (MG) configuration and MG activation information to the second network device and/or the terminal; and
sending a PRS processing window configuration to the second network device and/or the terminal.

According to a second aspect, a positioning method is provided. The method includes the following steps.

A terminal obtains target information.

The terminal initiates a positioning procedure based on the target information.

The positioning procedure includes at least one of the following:
sending target indication information to a first network device, where the target indication information indicates a PRS of a non-serving cell that does not meet a PRS measurement condition;
measuring the PRS;
on a premise that the terminal uses a BWP to measure the PRS, ignoring measurement performed on the PRS that does not meet the PRS measurement condition;
reporting a measurement result;
reporting position information; and
sending an MG request to a second network device, where the MG request is used to request to perform PRS measurement by using an MG.

According to a third aspect, a positioning apparatus is provided. The apparatus includes:
an obtaining module, configured to obtain first target information; and
an initiation module, configured to initiate a positioning procedure based on the first target information.

The positioning procedure includes at least one of the following:
sending target indication information to a second network device and/or a terminal, where the target indication information indicates information related to positioning reference signal PRS measurement of the terminal;
sending at least one of a measurement gap MG configuration and MG activation information to the second network device and/or the terminal; and
sending a PRS processing window configuration to the second network device and/or the terminal.

According to a fourth aspect, a positioning apparatus is provided. The apparatus includes:
an obtaining module, configured to obtain target information; and
an initiation module, configured to initiate a positioning procedure based on the target information.

The positioning procedure includes at least one of the following:
sending target indication information to a first network device, where the target indication information indicates a PRS of a non-serving cell that does not meet a PRS measurement condition;
measuring the PRS;
on a premise that the terminal uses a BWP to measure the PRS, ignoring measurement performed on the PRS that does not meet the PRS measurement condition;
reporting a measurement result;
reporting position information; and
sending a measurement gap MG request to a second network device, where the MG request is used to request to perform PRS measurement by using an MG.

According to a fifth aspect, a network-side device is provided. The network-side device includes a processor, a memory, and a program or an instruction that is stored in the memory and that can be run on the processor. When the program or the instruction is executed by the processor, steps of the positioning method according to the first aspect are implemented.

According to a sixth aspect, a terminal is provided. The terminal includes a processor, a memory, and a program or an instruction that is stored in the memory and that can be run on the processor. When the program or the instruction is executed by the processor, steps of the positioning method according to the second aspect are implemented.

According to a seventh aspect, a readable storage medium is provided. The readable storage medium stores a program or an instruction. When the program or the instruction is executed by a processor, steps of the positioning method according to the first aspect or the second aspect are implemented.

According to an eighth aspect, a chip is provided. The chip includes a processor and a communication interface. The communication interface is coupled to the processor, and the processor is configured to run a program or an instruction of a network-side device to implement steps of the positioning method according to the first aspect or the second aspect.

According to a ninth aspect, a computer program product is provided. The computer program product is stored in a storage medium. The computer program product is executed by at least one processor to implement steps of the positioning method according to any one of the first aspect or the second aspect.

According to a tenth aspect, a communication device is provided. The communication device is configured to perform steps of the positioning method according to the first aspect or the second aspect.

In embodiments of this application, a first network device obtains first target information. The first network device initiates a positioning procedure based on the first target information. The positioning procedure includes at least one of the following: sending target indication information to a second network device and/or a terminal, where the target indication information indicates a PRS measurement manner of the terminal; sending at least one of an MG configuration and MG activation information to the second network device and/or the terminal; and sending a PRS processing window configuration to the second network device and/or the terminal. The first network device initiates the positioning procedure in the foregoing manner, so that the terminal may perform positioning, to improve positioning performance.

### BRIEF DESCRIPTION OF DRAWINGS

FIG. 1 is a diagram of a structure of a network system according to an embodiment of this application;

FIG. 2 is a flowchart of a positioning method according to an embodiment of this application;

FIG. 3 is another flowchart of a positioning method according to an embodiment of this application;

FIG. 4 is a diagram of a structure of a positioning apparatus according to an embodiment of this application;

FIG. 5 is a diagram of another structure of a positioning apparatus according to an embodiment of this application;

FIG. 6 is a diagram of a structure of a communication device according to an embodiment of this application;

FIG. 7 is a diagram of a structure of a terminal according to an embodiment of this application; and

FIG. 8 is a diagram of a structure of a network-side device according to an embodiment of this application.

### DETAILED DESCRIPTION

The following clearly describes technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first,” “second,” and the like in the specification and claims of this application are used to distinguish between similar objects instead of describing a specific order or sequence. It should be understood that, data used in such a way is interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the specification and claims, “and/or” represents at least one of connected objects, and a character “/” generally represents an “or” relationship between associated objects. In this application, “transmission” means signal transmission, is not signal sending in a narrow sense.

It should be noted that, the technologies described in the embodiments of this application are not limited to a Long Term Evolution (LTE)/LTE-Advanced (LTE-A) system, and may also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The described technologies may be applied to both the systems and the radio technologies mentioned above as well as to other systems and radio technologies. However, the following description describes an NR system for illustrative purposes, and NR terms are used in most of the following description. These technologies may also be applied to an application other than an NR system application, such as a 6^{th} Generation (6G) communication system.

FIG. 1 is a diagram of a structure of a wireless communication system to which embodiments of this application may be applied. The wireless communication system includes a terminal 11 and a network-side device 12. The terminal 11 may also be referred to as a terminal device or User Equipment (UE). The terminal 11 may be a terminal-side device such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), or Pedestrian User Equipment (PUE). The wearable device includes a bracelet, a headset, glasses, and the like. It should be noted that a specific type of the terminal 11 is not limited in the embodiments of this application. The network-side device 12 may be a base station or a core network. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a WLAN access point, a Wi-Fi node, a Transmission and Reception Point (TRP), or another suitable term in the field. Provided that same technical effect is achieved, the base station is not limited to a specific technical term. It should be noted that in the embodiments of this application, only a base station in an NR system is used as an example, but a specific type of the base station is not limited.

With reference to the accompanying drawings, the following describes in detail a positioning method provided in the embodiments of this application by using embodiments and application scenarios thereof.

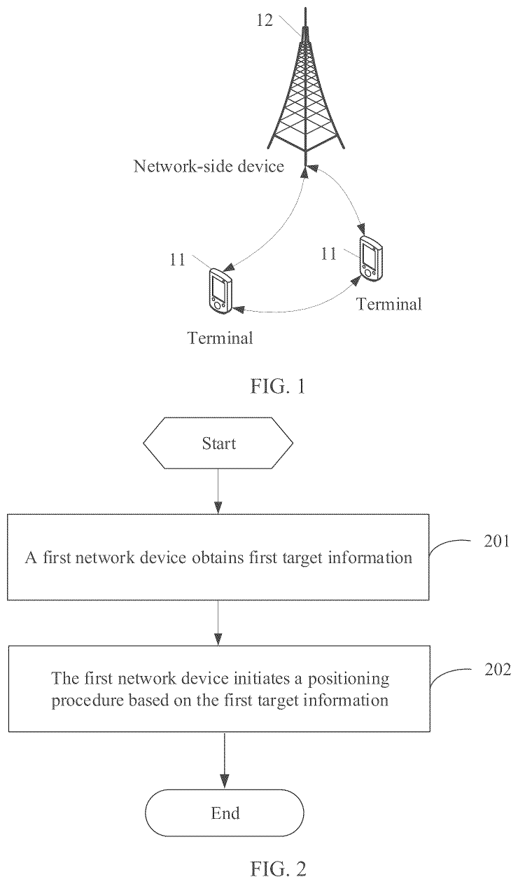

FIG. 2 is a flowchart of a positioning method according to an embodiment of this application. The positioning method includes the following steps.

Step 201: A first network device obtains first target information.

Step 202: The first network device initiates a positioning procedure based on the first target information.

The positioning procedure includes at least one of the following:
sending target indication information to a second network device and/or a terminal, where the target indication information indicates a PRS measurement manner of the terminal;
sending at least one of an MG configuration and MG activation information to the second network device and/or the terminal; and
sending a PRS processing window configuration to the second network device and/or the terminal.

In the foregoing, the first network device may be a (service) base station, and the second network device may be a position server. The first network device may determine, based on the first target information, whether a non-serving cell of the terminal meets a PRS measurement condition of the terminal, and initiates the positioning procedure based on a determination result. The PRS measurement condition includes but is not limited to: A receive timing difference between the non-serving cell of the terminal and a serving cell of the terminal is less than or equal to a target timing difference threshold. The target timing difference threshold may be obtained in at least one of manners such as protocol agreement, an indication of another node, or reporting of a terminal capability. The PRS measurement condition may be represented as a PRS synchronization condition. The non-serving cell of the terminal may also be understood as a neighboring cell of the terminal.

In some embodiments, that the receive timing difference between the non-serving cell of the terminal and a serving cell of the terminal is less than or equal to a target timing difference threshold may be understood as:
a timing difference between timing of the non-serving cell of the terminal and timing of the serving cell of the terminal is less than or equal to the target timing difference threshold; or a receive timing difference between receive timing of the non-serving cell of the terminal and receive timing of the serving cell of the terminal is less than or equal to the target timing difference threshold; or a receive timing difference between a PRS of the non-serving cell of the terminal and a PRS of the serving cell is less than or equal to the target timing difference threshold.

In this embodiment, the first network device obtains the first target information. The first network device initiates the positioning procedure based on the first target information. The positioning procedure includes at least one of the following: sending the target indication information to the second network device and/or the terminal, where the target indication information indicates the PRS measurement manner of the terminal; sending at least one of the MG configuration and the MG activation information to the second network device and/or the terminal; and sending the PRS processing window configuration to the second network device and/or the terminal. The first network device initiates the positioning procedure in the foregoing manner, so that the terminal may perform positioning, to improve positioning performance.

In this application, using an active Bandwidth Part (BWP) to measure the PRS may be understood as “using a PRS processing window to measure the PRS,” or “measuring the PRS in a case of MG-less,” or “measuring the PRS in a case that no measurement gap exists,” or “measuring the PRS outside the MG.”

In the foregoing, the first target information includes at least one of the following:
information about the non-serving cell of the terminal;
capability information of the terminal;
timing difference threshold information; and
indication information sent by the second network device.

The non-serving cell of the terminal includes all or some of the non-serving cells corresponding to PRSs measured by the terminal. The information about the non-serving cell of the terminal or the capability information of the terminal or both are obtained from the terminal, or the information about the non-serving cell of the terminal or the capability information of the terminal or both are obtained from the second network device.

The information about the non-serving cell of the terminal includes at least one of the following:
time information of the non-serving cell of the terminal;
frequency domain information of the non-serving cell of the terminal; and
identifier information of the non-serving cell of the terminal.

The time information of the non-serving cell includes at least one of the following:
an expected reference signal time difference and uncertainty between the non-serving cell and a reference cell or the first network device (for example, a base station), or an offset between a system frame number 0 (System Frame Number 0, SFN0) of a PRS search window (expected Reference Signal Time Difference (RSTD)±uncertainty) or, the non-serving cell and a system frame number 0 of the reference cell or the first network device, for example, SFN0-offset, SFN initialization time of the non-serving cell, synchronization information (for example, Relative Time Difference (RTD) information, and time synchronization information used between two cells) between the non-serving cells (or between the non-serving cell and the reference cell, or between the non-serving cell and the serving cell). Herein, timing of the serving cell is timing of a primary cell.

The frequency domain information of the non-serving cell includes at least one of the following: a positioning frequency layer identifier, a frequency, a point-A, bandwidth, a subcarrier spacing, a start frequency domain position, and the like corresponding to the non-serving cell.

The identifier information of the non-serving cell includes at least one of the following: the positioning frequency layer identifier, a TRP identifier, a PRS resource set identifier, a PRS identifier, a Physical Cell Identifier (PCI), an NR Cell Global Identifier (NCGI), and an Absolute Radio Frequency Channel Number (ARFCN).

In the foregoing, the indication information indicates whether to determine that whether the non-serving cell of the terminal meets the PRS measurement condition. In other words, the indication information indicates whether the first network device determines whether the non-serving cell meets the PRS measurement condition. For example, if the second network device (for example, a position server) obtains a UE capability and supports sliding correlation, there is no need to determine whether the non-serving cell meets the PRS measurement condition. In some embodiments, an implicit indication may also be used, for example, if the indication information sent by the second network device does not include at least one of the information about the non-serving cell of the terminal, the UE capability, and the timing difference threshold information, the first network device does not need to determine whether the non-serving cell meets the PRS measurement condition.

In an embodiment of this application, the positioning procedure further includes one of the following:
configuring, for the terminal, the MG that is used to measure a first target PRS;
deleting a to-be-measured PRS configuration from the processing window;
indicating the terminal to ignore measurement performed on the to-be-measured PRS; and
sending, to the second network device, information that indicates the to-be-measured PRS.

The configuring, for the terminal, the MG that is used to measure a first target PRS includes: The first network device configures, for the terminal and based on a relationship between the first target PRS and second target information, and the first target information, the MG that is used to measure the first target PRS, where the second target information includes at least one of a Subcarrier Spacing (SCS) of the BWP and a bandwidth relationship. In other words, the MG configuration is determined by the first network device based on the relationship between the first target PRS to be measured by the terminal and the second target information, and the first target information. The MG configuration includes configuration information for the terminal to use the MG to perform PRS measurement on the first target PRS. The first target PRS includes a PRS of a non-serving cell that is in the non-serving cells of the terminal and that meets the PRS measurement condition.

If the first network device determines that the non-serving cell of the terminal does not meet the PRS measurement condition, the first network device (forcibly) configures the MG to a specified PRS (that is, the PRS of the non-serving cell that does not meet the PRS measurement condition) (or for some PRSs, the first network device still configures the MG), or deletes a configuration of the specified PRS from a corresponding processing window, or indicates the UE to ignore the measurement performed on the specified PRS, or indicates the PRS that does not meet the condition to the second network device (the position server). In some embodiments, (at a positioning frequency layer), if there are more than N non-serving cells (or TRPs) that do not meet the measurement condition, a related indication is sent, for example, the target indication information is sent; or (at a positioning frequency layer), if there are less than M non-serving cells (or TRPs) that meet the measurement condition, the related indication is sent, for example, the target indication information is sent. N and M may be obtained in at least one of manners such as an indication of a network, protocol agreement, or an indication of the UE.

In an embodiment of this application, after obtaining the first target information, the first network device may determine, based on the first target information, whether the non-serving cell of the terminal meets the PRS measurement condition, and sends the target indication information to the second network device. The target indication information indicates a second target PRS. The second target PRS includes the PRS of the non-serving cell that is in the non-serving cells of the terminal and that does not meet the PRS measurement condition. The second network device may further send the target indication information to the UE.

In some embodiments, the second target PRS includes at least one of a PRS of at least one non-serving cell, a PRS of at least one TRP, and at least one PRS of at least one positioning frequency layer. The second target PRS includes at least one of the following: the positioning frequency layer identifier, the TRP identifier, the PRS resource set identifier, the PRS identifier, an identifier of a cell that sends the PRS, a quantity of the cell or TRP, and the like. The target indication information indicates that PRSs corresponding to these identifiers do not meet a measurement threshold, or indicates that the UE may ignore the PRSs corresponding to these identifiers.

In an embodiment of this application, the target indication information indicates that when the terminal uses the active BWP to perform PRS measurement, the terminal ignores measurement performed on a third target PRS and/or performs measurement on a fourth target PRS. In other words, the target indication information indicates that when the UE uses the BWP to measure the PRS, the UE ignores the measurement performed on the third target PRS, and/or indicates the PRS (that is, the fourth target PRS) that should be measured when the UE uses the BWP to measure the PRS. The target indication information may be included in an indication of the PRS processing window configuration. In some embodiments, the indication of the PRS processing window configuration is not related to the third target PRS, for example, the indication of the PRS processing window configuration indicates that the UE ignores the measurement performed on the third target PRS (explicit indication); or the indication of the PRS processing window configuration does not include a configuration of the third target PRS (implicit indication). That is, the PRS processing window configuration is not related to the third target PRS. In some embodiments, the PRS processing window configuration indicates the measurement performed on the fourth target PRS (explicit indication) by the UE; or the PRS processing window configuration only includes the fourth target PRS (implicit indication).

The third target PRS includes the PRS of the non-serving cell that does not meet the PRS measurement condition, and/or the fourth target PRS includes the PRS of the non-serving cell that meets the PRS measurement condition.

The third target PRS includes at least one of the following:
a PRS of at least one non-serving cell;
a PRS of at least one TRP; and
a PRS of at least one positioning frequency layer;
and/or
the fourth target PRS includes at least one of the following:
a PRS of at least one non-serving cell;
a PRS of at least one TRP; and
a PRS of at least one positioning frequency layer.

The third target PRS includes at least one of the following:
a positioning frequency layer identifier corresponding to the third target PRS;
a TRP identifier corresponding to the third target PRS;
a PRS resource set identifier corresponding to the third target PRS;
an identifier of the third target PRS; and
an identifier of a cell that sends the third target PRS;
and/or
the fourth target PRS includes at least one of the following:
a positioning frequency layer identifier corresponding to the fourth target PRS;
a TRP identifier corresponding to the fourth target PRS;
a PRS resource set identifier corresponding to the fourth target PRS;
an identifier of the fourth target PRS; and
an identifier of a cell that sends the fourth target PRS.

The fourth target PRS is a PRS in PRS configuration information, and the PRS configuration information is related to using, by the terminal, the active BWP for measurement. In some embodiments, the PRS configuration information is different from the PRS configuration that is used by the UE and that corresponds to the MG, and the PRS configuration information is only used in a case of using the BWP for measurement. In some embodiments, the PRS configuration is related to the PRS processing window, or the PRS configuration is the PRS configuration used when the UE uses the active BWP or the PRS processing window to measure the PRS. For example, the fourth target PRS configuration carries an identifier for identifying that the PRS configuration is used to measure the PRS by using the BWP.

In an embodiment of this application, the PRS processing window configuration does not include a configuration of a fifth target PRS, or the PRS processing window configuration is not related to the fifth target PRS.

In some embodiments, the fifth target PRS includes at least one of the following:
a PRS of at least one non-serving cell;
a PRS of at least one TRP;
a PRS of at least one positioning frequency layer; and
the PRS of the non-serving cell that does not meet the PRS measurement condition.

In an embodiment of this application, the target indication information indicates at least one of the following: whether the terminal may request the MG, whether the terminal may request the PRS processing window, whether the second network device has requested the MG, whether the second network device has requested the PRS processing window, a manner in which the terminal requests the MG, and a manner in which the terminal requests the PRS processing window. The manner for requesting the MG or the manner for requesting the PRS processing window is, for example, requesting by using a Media Access Control (MAC) Control Element (CE), or requesting by using Radio Resource Control (RRC), or requesting by using Uplink control information (UCI).

In some embodiments, whether the second network device has requested the MG and/or the PRS processing window means that the second network device requests the first network device for the MG and/or the PRS processing window by using an NR positioning protocol A (NRPPa).

In some embodiments, whether the terminal may request the MG and/or the PRS processing window means whether the first network device or the second network device allows the terminal to request the first network device for the MG and/or the PRS processing window through signaling.

In some embodiments, if the terminal receives the target indication information, a location information request, or a later message of the target indication information and the location information request, a timer is started, an MG configuration (or activation) message or a PRS processing window configuration (or activation) message is received in the timer. After the timer ends (or is released, or stops), if the terminal does not receive the MG configuration (or activation) message or the PRS processing window configuration (or activation) message, the UE initiates a request for the MG or PRS processing window configuration (or activation) to the first network device (or the second network device), and/or reports information about failure of the MG or PRS processing window configuration.

In some embodiments, if the terminal receives the target indication information, the location information request, or the later message of the target indication information and the location information request, the timer is started, the MG configuration (or activation) message is received in the timer. After the timer ends (or is released, or stops), if the terminal does not receive the MG configuration (or activation) message, the UE initiates the request for the MG configuration (or activation) to the first network device (or the second network device), and/or reports the information about the failure of the MG configuration. In some embodiments, the timer is only used in a case that the terminal uses the MG to measure the PRS. If the terminal determines or receives an indication and confirms that the target PRS may use the active BWP for measurement, the terminal ignores the timer.

In some embodiments, start time of the timer is time when the terminal receives the target indication information, the location information request, or the later message of the target indication information and the location information request. A length (or end time) of the timer may be determined based on at least one of an indication of a network device (the first network device or the second network device), the protocol agreement, or selection of the terminal.

In another embodiment of this application, before or after the first network device sends the target indication information, the indication information from the second network device or the terminal is obtained. The indication information indicates requirement information of a positioning service of the terminal (for example, indication from the first network device to the second network device), and includes at least one of a Quality of Service (QOS) requirement and a terminal measurement performance requirement. The QoS requirement includes at least one of a positioning precision requirement and positioning delay requirement. In some embodiments, terminal measurement performance requirement information is a measurement performance requirement corresponding to a current terminal measurement quantity (such as an RSTD, Reference Signal Received Power (RSRP), or Rx-Tx time difference), represents a requirement that the measurement quantity reported by the terminal should meet, and includes at least one of a precision measurement performance requirement and a delay measurement performance requirement. For example, the precision measurement performance requirement is indicated, and a requirement table in which precision corresponds to a PRS bandwidth, a signal-to-noise ratio, a subcarrier spacing, a channel type, and the like is indicated.

In the foregoing embodiment, capability information of the terminal includes at least one of the following:
whether to support PRS processing performed in an active Downlink (DL) BWP (or in the PRS processing window);
whether to support PRS processing performed by using an MG;
a processing capability of using the MG to process the PRS;
a processing capability of processing the PRS in the active DL BWP (or in the PRS processing window);
whether to support PRS processing performed by using sliding correlation and/or Fast Fourier Transformation (FFT), and further, whether to support PRS processing performed by using the sliding correlation and/or FFT under a condition of performing PRS processing in the active DL BWP and/or under a condition of performing PRS processing by using the MG;
whether to support processing a PRS of an asynchronous neighboring cell, and further, whether to support processing of the PRS of the asynchronous neighboring cell under the condition of performing PRS processing in the active DL BWP and/or under the condition of performing PRS processing by using the MG;
whether to support processing the PRS of the non-serving cell in a manner of ignoring the timing difference threshold, and further, whether to support processing of the PRS of the non-serving cell performed by ignoring the timing difference threshold under the condition of performing PRS processing in the active DL BWP and/or under the condition of performing PRS processing by using the MG;
a threshold range of receive timing difference between a non-serving cell and a serving cell for supporting PRS processing, and further, the threshold range of the receive timing difference between the non-serving cell and the serving cell for supporting PRS processing under the condition of performing PRS processing in the active DL BWP and/or under the condition of performing PRS processing by using the MG, for example, a (maximum +−) threshold of a Receive (Rx) timing difference between the non-serving cell and the serving cell for PRS processing, where, when the value is defaulted, or is 0, or is a maximum value, it may be indicated that the UE can ignore the timing difference threshold to process the PRS of the non-serving cell; and
whether to support processing the PRS of the non-serving cell that exceeds the timing difference threshold, and further, whether to support processing the PRS of the non-serving cell that exceeds the timing difference threshold under the condition of performing PRS processing in the active DL BWP and/or under the condition of performing PRS processing by using the MG. In some embodiments, the timing difference threshold is determined in at least one of manners of: indicating by a network, defined by the protocol, or selected by the terminal. For example, the timing difference threshold is a length of a Cyclic Prefix (CP).

In some embodiments, a capability type of the terminal may be per terminal (per UE) or per band.

The UE may report the capability information to the first network device and/or the second network device. The capability information of the terminal may be reported separately, or may be included in a capability related to using the active BWP (or using the PRS processing window) to measure the PRS.

Herein, the sliding correlation may further be understood as: time domain-related processing or time domain processing. The FFT processing may further be understood as: Discrete Fourier transformation (DFT) processing, or frequency domain sampling processing, or frequency domain processing.

In some embodiments, the receive timing difference between the non-serving cell of the terminal and the serving cell of the terminal may be understood as:
a timing difference between timing of the non-serving cell of the terminal and timing of the serving cell of the terminal; or a receive timing difference between receive timing of the non-serving cell of the terminal and receive timing of the serving cell of the terminal; or a receive timing difference between the PRS of the non-serving cell of the terminal and the PRS of the serving cell; or a receive timing difference between the PRS of the non-serving cell of the terminal and timing of the serving cell.

A case that the capability information of the terminal is sent to the first network device may be that the UE directly sends the capability information to the first network device, or may be that the UE sends the capability information to the second network device, and then the second network device sends the capability information to the first network device.

If the UE capability supports PRS processing performed by using the sliding correlation or supports the PRS processing of the asynchronous neighboring cell by using the sliding correlation, or when the Rx timing difference between non-serving cell and the serving cell for PRS processing is large, it may be considered that the UE may process the PRS of the non-serving cell by ignoring the PRS measurement condition.

In some embodiments, the target indication information indicates the terminal to use the active BWP to perform PRS measurement on a premise of at least one of the following assumptions:
all to-be-measured non-serving cells meet the PRS measurement condition;
all the to-be-measured non-serving cells are synchronized with the serving cell; and
when the terminal supports a sliding window, whether all the to-be-measured non-serving cells meet the PRS measurement condition is ignored, or whether all the to-be-measured non-serving cells are synchronized with the serving cell is ignored.

In other words, under a solution that the first network device determines, based on target information, whether the non-serving cell of the terminal meets the PRS measurement condition of the terminal, when the terminal measures the PRS in the active BWP, assumptions of the UE includes at least one of the following:
when the UE uses the active DL BWP to measure the PRS, the UE assumes that all to-be-measured TRPs of neighboring cells meet a condition threshold;
when the UE uses the active DL BWP to measure the PRS, the UE assumes that all the to-be-measured TRPs of the neighboring cells are synchronized with the serving cell; and
if the UE may support the sliding window, when the UE uses the active DL BWP to measure the PRS, the UE ignores whether all the to-be-measured TRPs of the neighboring cells meet the condition threshold, or ignores whether all the to-be-measured TRPs of the neighboring cells are synchronized with the serving cell.

In some alternative embodiments, when the terminal measures the PRS in the active BWP, the assumptions of the UE includes at least one of the following:
when the UE uses the active DL BWP to measure the PRS, the UE assumes that all the to-be-measured TRPs of the neighboring cells meet the condition threshold;
when the UE uses the active DL BWP to measure the PRS, the UE assumes that all the to-be-measured TRPs of the neighboring cells are synchronized with the serving cell; and
if the UE may support the sliding window, when the UE uses the active DL BWP to measure the PRS, the UE ignores whether all the to-be-measured TRPs of the neighboring cells meet the condition threshold, or ignores whether all the to-be-measured TRPs of the neighboring cells are synchronized with the serving cell.

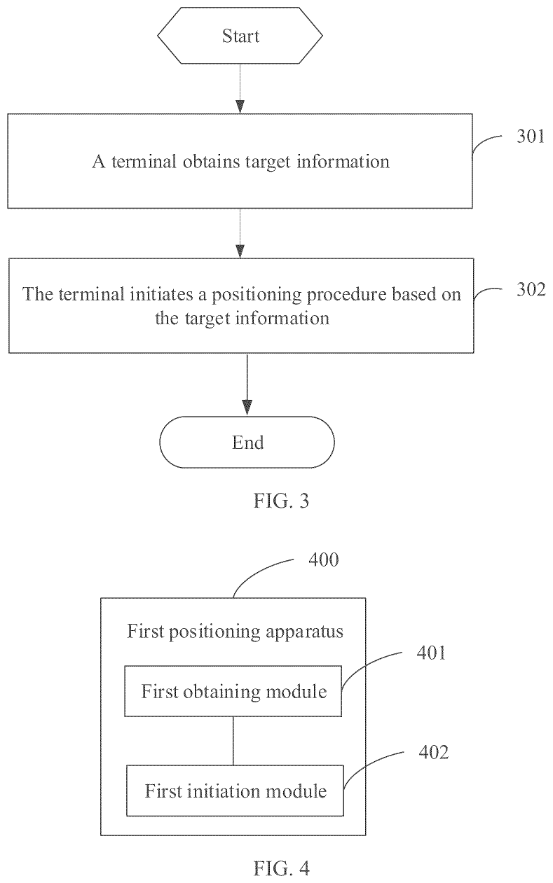

FIG. 3 is a flowchart of a positioning method according to an embodiment of this application. As shown in FIG. 3, the positioning method provided in this embodiment of this application includes the following steps.

Step 301: A terminal obtains target information.

Step 302: The terminal initiates a positioning procedure based on the target information.

The positioning procedure includes at least one of the following:
sending target indication information to a first network device, where the target indication information indicates a PRS of a non-serving cell that does not meet a PRS measurement condition;
measuring the PRS;
on a premise that the terminal uses a BWP to measure the PRS, ignoring measurement performed on the PRS that does not meet the measurement condition;
reporting a measurement result;
reporting position information; and
sending a measurement gap MG request to a second network device, where the MG request is used to request to perform PRS measurement by using an MG.

For example, the first network device may be a base station, and the second network device may be a position server. The terminal determines, based on target information, whether the non-serving cell of the terminal meets the PRS measurement condition; and the terminal initiates the positioning procedure based on whether the non-serving cell of the terminal meets the PRS measurement condition. The PRS measurement condition includes but is not limited to: A receive timing difference between the non-serving cell of the terminal and a serving cell of the terminal is less than or equal to a target timing difference threshold. The target timing difference threshold may be obtained in at least one of manners such as protocol agreement, an indication of another node, or reporting of a terminal capability. The PRS measurement condition may be represented as a PRS synchronization condition. The non-serving cell of the terminal may also be understood as a neighboring cell of the terminal.

In some embodiments, that the receive timing difference between the non-serving cell of the terminal and a serving cell of the terminal is less than or equal to a target timing difference threshold may be understood as:
a timing difference between timing of the non-serving cell of the terminal and timing of the serving cell of the terminal is less than or equal to the target timing difference threshold; or a receive timing difference between receive timing of the non-serving cell of the terminal and receive timing of the serving cell of the terminal is less than or equal to the target timing difference threshold; or a receive timing difference between a PRS of the non-serving cell of the terminal and a PRS of the serving cell is less than or equal to the target timing difference threshold. The serving cell includes at least one of a primary cell, a primary secondary cell, or a secondary cell.

In this embodiment, the terminal obtains the target information. The terminal initiates the positioning procedure based on the target information. The positioning procedure includes at least one of the following: sending the target indication information to the first network device, where the target indication information indicates the PRS of the non-serving cell that does not meet the PRS measurement condition; measuring the PRS; on the premise that the terminal uses the BWP to measure the PRS, ignoring measurement performed on the PRS that does not meet the measurement condition; reporting the measurement result; reporting the position information; and sending the measurement gap MG request to the second network device, where the MG request is used to request to perform PRS measurement by using the MG. The terminal initiates the positioning procedure in the foregoing manner, so that the terminal may perform positioning, to improve positioning performance.

In this application, using an active BWP to measure the PRS may be understood as “using a PRS processing window to measure the PRS,” or “measuring the PRS in a case of MG-less,” or “measuring the PRS in a case that no MG exists,” or “measuring the PRS outside the MG.”

In the foregoing, the target information includes at least one of the following:
information about the non-serving cell (or a TRP) of the terminal; and
timing difference threshold information.

The non-serving cell of the terminal includes all or some of the non-serving cells of PRSs measured by the terminal.

The information about the non-serving cell of the terminal includes at least one of the following:
time information of the non-serving cell of the terminal;
frequency domain information of the non-serving cell of the terminal; and
identifier information of the non-serving cell of the terminal.

The time information of the non-serving cell includes at least one of the following:
expected RSTD+/−uncertainty between the non-serving cell and a reference cell or the first network device (for example, a base station), an offset between a System Frame Number (SFN) of the non-serving cell and a system frame number of the reference cell or the first network device, for example, SFN0-offset, SFN initialization time of the non-serving cell, synchronization information (for example, RTD information) between the non-serving cells.

The frequency domain information of the non-serving cell includes at least one of the following: a positioning frequency layer identifier, a frequency, a point-A, bandwidth, a subcarrier spacing, a start frequency domain position, and the like corresponding to the non-serving cell.

The identifier information of the non-serving cell includes at least one of the following: the positioning frequency layer identifier, a TRP identifier, a PRS resource set identifier, a PRS identifier, a Physical Cell Identifier (PCI), an NR Cell Global Identifier (NCGI), and an ARFCN.

The information about the non-serving cell of the terminal is obtained from the first network device, or is obtained from the second network device.

In an embodiment of this application, after UE obtains the target information, if the UE expects to use the MG to measure a first target PRS, the UE sends the MG request to the first network device. The MG request is used to request to perform PRS measurement on the first target PRS by using the MG.

The first target PRS includes at least one of the following:
a PRS of at least one non-serving cell;
a PRS of at least one TRP;
a PRS of at least one positioning frequency layer;
the PRS of the non-serving cell that does not meet the PRS measurement condition; and
a PRS that does not match a current active BWP of the terminal.

In some embodiments, (at a positioning frequency layer), if there are more than N non-serving cells (or TRPs) that do not meet a measurement condition, a related indication is sent, for example, the MG request is sent; or (at a positioning frequency layer), if there are less than M non-serving cells (or TRPs) that meet the measurement condition, the related indication is sent, for example, the MG request is sent. N and M may be obtained in at least one of the manners such as an indication of a network, protocol agreement, or an indication of the UE.

The PRS (for ease of description, the PRS is referred to as a first PRS) that does not match the current active BWP of the terminal meets at least one of the following:
bandwidth of the first PRS does not match the active BWP;
an SCS of the first PRS does not match the active BWP; and
a precision requirement of the first PRS does not match bandwidth in the active BWP.

In an embodiment of this application, after the UE obtains the target information, for the PRS that does not meet the PRS measurement condition, the UE does not expect to perform measurement and report a corresponding measurement result. In this case, on the premise that the UE may use the active BWP to measure the PRS, the UE ignores measurement performed on the PRS that does not meet the measurement condition.

In an embodiment of this application, after the UE obtains the target information, for the PRS that does not meet the PRS measurement condition, the UE may send the target indication information to the second network device (that is, the position server) to indicate that a second target PRS does not meet the measurement condition. The second target PRS includes a PRS of at least one non-serving cell and/or a PRS of at least one TRP.

The second target PRS includes at least one of the following: the positioning frequency layer identifier, the TRP identifier, the PRS resource set identifier, the PRS identifier, an identifier of a cell that sends the PRS, a quantity of the cell or TRP, and the like. The target indication information indicates that PRSs corresponding to these identifiers do not meet a measurement threshold, or indicates that the UE may ignore the PRSs corresponding to these identifiers. In some embodiments, the target indication information may be included in a positioning measurement report.

It should be noted that the positioning method provided in the embodiments of this application may be performed by a positioning apparatus, or a control module that is in the positioning apparatus and that is configured to perform the positioning method.

In the following embodiments, an example in which the positioning apparatus performs the positioning method is used to describe the positioning apparatus provided in the embodiments of this application.

FIG. 4 is a diagram of a structure of a positioning apparatus according to an embodiment of this application. The first positioning apparatus 400 includes:
a first obtaining module 401, configured to obtain first target information; and
a first initiation module 402, configured to initiate a positioning procedure based on the first target information.

The positioning procedure includes at least one of the following:
sending target indication information to a second network device and/or a terminal, where the target indication information indicates information related to positioning reference signal PRS measurement of the terminal;
sending at least one of a measurement gap MG configuration and MG activation information to the second network device and/or the terminal; and
sending a PRS processing window configuration to the second network device and/or the terminal.

In some embodiments, the first target information includes at least one of the following:
information about the non-serving cell of the terminal;
capability information of the terminal;
timing difference threshold information; and
indication information sent by the second network device.

In some embodiments, the non-serving cell of the terminal includes all or some of the non-serving cells corresponding to PRSs measured by the terminal.

In some embodiments, the information about the non-serving cell of the terminal includes at least one of the following:
time information of the non-serving cell of the terminal;
frequency domain information of the non-serving cell of the terminal; and
identifier information of the non-serving cell of the terminal.

In some embodiments, the information about the non-serving cell of the terminal or the capability information of the terminal or both are obtained from the terminal, or are obtained from the second network device.

In some embodiments, the indication information indicates whether to determine whether the non-serving cell of the terminal meets the PRS measurement condition.

In some embodiments, the MG configuration is determined by the first network device based on a relationship between a first target PRS to be measured by the terminal and second target information, and the first target information. The MG configuration includes configuration information for the terminal to use the MG to perform PRS measurement on the first target PRS. The second target information includes at least one of an SCS of a BWP and a bandwidth relationship.

In some embodiments, the target indication information indicates a second target PRS. The second target PRS includes a PRS of a non-serving cell that is in the non-serving cells of the terminal and that does not meet the PRS measurement condition.

In some embodiments, the target indication information indicates that when the terminal uses an active BWP to perform PRS measurement, the terminal ignores measurement performed on a third target PRS and/or performs measurement on a fourth target PRS.

In some embodiments, the third target PRS includes at least one of the following:
a PRS of at least one non-serving cell;
a PRS of at least one TRP; and
a PRS of at least one positioning frequency layer;
and/or
the fourth target PRS includes at least one of the following:
a PRS of at least one non-serving cell;
a PRS of at least one TRP; and
a PRS of at least one positioning frequency layer.

In some embodiments, the third target PRS includes the PRS of the non-serving cell that does not meet the PRS measurement condition, and/or the fourth target PRS includes the PRS of the non-serving cell that meets the PRS measurement condition.

In some embodiments, the third target PRS includes at least one of the following:
a positioning frequency layer identifier corresponding to the third target PRS;
a TRP identifier corresponding to the third target PRS;
a PRS resource set identifier corresponding to the third target PRS;
an identifier of the third target PRS; and
an identifier of a cell that sends the third target PRS;
and/or
the fourth target PRS includes at least one of the following:
a positioning frequency layer identifier corresponding to the fourth target PRS;
a TRP identifier corresponding to the fourth target PRS;
a PRS resource set identifier corresponding to the fourth target PRS;
an identifier of the fourth target PRS; and
an identifier of a cell that sends the fourth target PRS.

In some embodiments, the fourth target PRS is a PRS in PRS configuration information, and the PRS configuration information is related to using, by the terminal, the active BWP for measurement.

In some embodiments, the PRS processing window configuration does not include a configuration of a fifth target PRS, or the PRS processing window configuration is not related to the fifth target PRS.

In some embodiments, the fifth target PRS includes at least one of the following:
a PRS of at least one non-serving cell;
a PRS of at least one TRP;
a PRS of at least one positioning frequency layer; and
the PRS of the non-serving cell that does not meet the PRS measurement condition.

In some embodiments, the target indication information indicates at least one of the following: whether the terminal may request the MG, whether the terminal may request the PRS processing window, whether the second network device has requested the MG, whether the second network device has requested the PRS processing window, a manner in which the terminal requests the MG, and a manner in which the terminal requests the PRS processing window.

In some embodiments, the capability information of the terminal includes at least one of the following:
whether to support PRS processing in an active downlink DL BWP;
whether to support PRS processing performed by using the MG;
a processing capability of using the MG to process the PRS;
a processing capability of using the active DL BWP to process the PRS;
whether to support PRS processing performed by using sliding correlation and/or FFT;
whether to support processing of a PRS of an asynchronous neighboring cell;
whether to support processing of the PRS of the non-serving cell performed by ignoring a timing difference threshold; and
a threshold range of a receive timing difference between a non-serving cell and a serving cell for supporting PRS processing.

In some embodiments, the target indication information indicates the terminal to use the active BWP to perform PRS measurement on a premise of at least one of the following assumptions:
all to-be-measured non-serving cells meet the PRS measurement condition;
all the to-be-measured non-serving cells are synchronized with the serving cell; and
when the terminal supports a sliding window, whether all the to-be-measured non-serving cells meet the PRS measurement condition is ignored, or whether all the to-be-measured non-serving cells are synchronized with the serving cell is ignored.

In some embodiments, the PRS measurement condition includes that a receive timing difference between the non-serving cell of the terminal and the serving cell of the terminal is less than or equal to a target timing difference threshold.

A first positioning apparatus 400 provided in this embodiment of this application can implement processes implemented in the method embodiment in FIG. 2 and achieve same technical effect. To avoid repetition, details are not described herein again.

FIG. 5 is a diagram of a structure of a positioning apparatus according to an embodiment of this application. The second positioning apparatus 500 includes:
a second obtaining module 501, configured to obtain target information; and
a second initiation module 502, configured to initiate a positioning procedure based on the target information.

The positioning procedure includes at least one of the following:
sending target indication information to a first network device, where the target indication information indicates a PRS of a non-serving cell that does not meet a PRS measurement condition;
measuring the PRS;
on a premise that the terminal uses a BWP to measure the PRS, ignoring measurement performed on the PRS that does not meet the PRS measurement condition;
reporting a measurement result;
reporting position information; and
sending a measurement gap MG request to a second network device, where the MG request is used to request to perform PRS measurement by using an MG.

In some embodiments, the target information includes at least one of the following:
information about the non-serving cell of the terminal; and
timing difference threshold information.

In some embodiments, the non-serving cell of the terminal includes all or some of the non-serving cells of PRSs measured by the terminal.

In some embodiments, the information about the non-serving cell of the terminal includes at least one of the following:
time information of the non-serving cell of the terminal;
frequency domain information of the non-serving cell of the terminal; and
identifier information of the non-serving cell of the terminal.

In some embodiments, the information about the non-serving cell of the terminal is

obtained from the first network device, or is obtained from the second network device.

In some embodiments, the second initiation module includes:
a determination submodule, configured to determine, based on the target information, whether the non-serving cell of the terminal meets the PRS measurement condition; and
an initiation submodule, configured to initiate the positioning procedure based on whether the non-serving cell of the terminal meets the PRS measurement condition.

In some embodiments, the MG request is used to request to perform PRS measurement on a first target PRS by using the MG.

In some embodiments, the first target PRS includes at least one of the following:
a PRS of at least one non-serving cell;
a PRS of at least one TRP;
a PRS of at least one positioning frequency layer;
the PRS of the non-serving cell that does not meet the PRS measurement condition; and
a PRS that does not match a current active BWP of the terminal.

In some embodiments, the PRS measurement condition includes that a receive timing difference between the non-serving cell of the terminal and a serving cell of the terminal is less than or equal to a target timing difference threshold.

The second positioning apparatus 500 in this embodiment of this application may be an apparatus, or may be a component, an integrated circuit, or a chip in the terminal.

The second positioning apparatus 500 in this embodiment of this application may be an apparatus with an operating system. The operating system may be an Android operating system, may be an iOS operating system, or may be another possible operating system. This is not specifically limited in this embodiment of this application.

The second positioning apparatus 500 provided in this embodiment of this application can implement processes implemented in the method embodiment in FIG. 3 and achieve same technical effect. To avoid repetition, details are not described herein again.

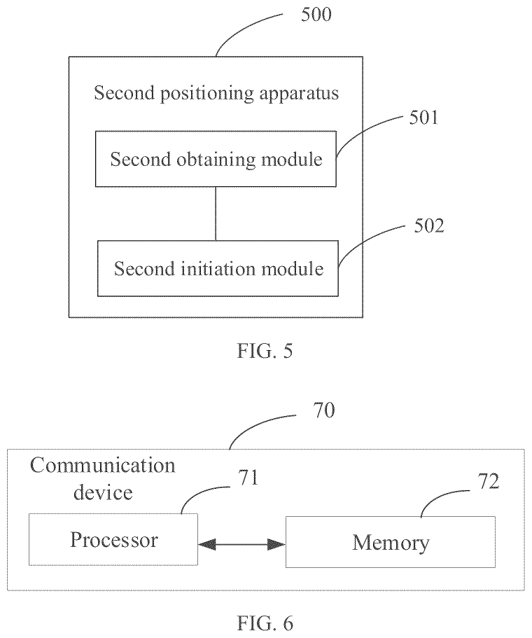

For example, as shown in FIG. 6, an embodiment of this application further provides a communication device 70. The communication device 70 includes a processor 71, a memory 72, and a program or an instruction that is stored in the memory 72 and that can be run on the processor 71. For example, when the communication device 70 is a terminal, and the program or the instruction is executed by the processor 71, processes in the positioning method embodiment shown in FIG. 3 are implemented, and same technical effect can be achieved. When the communication device 70 is a network-side device, and the program or the instruction is executed by the processor 71, processes in the positioning method embodiment shown in FIG. 2 are implemented, and same technical effect can be achieved.

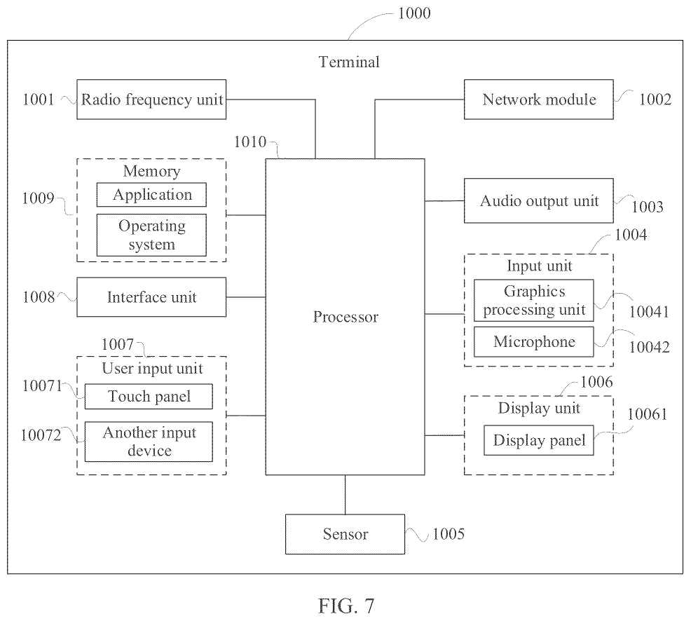

FIG. 7 is a schematic diagram of a hardware structure of a terminal according to an embodiment of this application.

The terminal 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The structure of the terminal shown in FIG. 7 constitutes no limitation on the terminal. The terminal may include more or fewer components than those shown in the figure, combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061. The display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network-side device, the radio frequency unit 1001 sends the downlink data to the processor 1010 for processing, and sends uplink data to the base station. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a program or instruction storage area and a data storage area. The program or instruction storage area may store an operating system, an application or an instruction required by at least one function (for example, a sound playing function or an image playing function), and the like. In addition, the memory 1009 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 1010 may include one or more processing units. In some embodiments, an application processor and a modem processor may be integrated into the processor 1010. The application processor mainly processes an operating system, a user interface, an application, an instruction, or the like. The modem processor mainly processes wireless communication, for example, a baseband processor. It may be understood that the modem processor may not be integrated into the processor 1010.

The radio frequency unit 1001 is configured to obtain target information.

The processor 1010 is configured to initiate a positioning procedure based on the target information.

The positioning procedure includes at least one of the following:
sending target indication information to a first network device, where the target indication information indicates a PRS of a non-serving cell that does not meet a PRS measurement condition;
measuring the PRS;
on a premise that the terminal uses a BWP to measure the PRS, ignoring measurement performed on the PRS that does not meet the PRS measurement condition;
reporting a measurement result;
reporting position information; and
sending a measurement gap MG request to a second network device, where the MG request is used to request to perform PRS measurement by using an MG.

In some embodiments, the target information includes at least one of the following:
information about the non-serving cell of the terminal; and
timing difference threshold information.

In some embodiments, the non-serving cell of the terminal includes all or some of the non-serving cells of PRSs measured by the terminal.

In some embodiments, the information about the non-serving cell of the terminal includes at least one of the following:
time information of the non-serving cell of the terminal;
frequency domain information of the non-serving cell of the terminal; and
identifier information of the non-serving cell of the terminal.

In some embodiments, the information about the non-serving cell of the terminal is obtained from the first network device, or is obtained from the second network device.

In some embodiments, the processor 1010 is configured to: determine, based on the target information, whether the non-serving cell of the terminal meets the PRS measurement condition; and initiate the positioning procedure based on whether the non-serving cell of the terminal meets the PRS measurement condition.

In some embodiments, the MG request is used to request to perform PRS measurement on a first target PRS by using the MG.

In some embodiments, the first target PRS includes at least one of the following:
a PRS of at least one non-serving cell;
a PRS of at least one TRP;
a PRS of at least one positioning frequency layer;
the PRS of the non-serving cell that does not meet the PRS measurement condition; and
a PRS that does not match a current active BWP of the terminal.

In some embodiments, the PRS measurement condition includes that a receive timing difference between the non-serving cell of the terminal and a serving cell of the terminal is less than or equal to a target timing difference threshold.

The terminal 1000 provided in the foregoing embodiment can implement processes implemented in the method embodiment in FIG. 3 and achieve same technical effect. To avoid repetition, details are not described herein again.

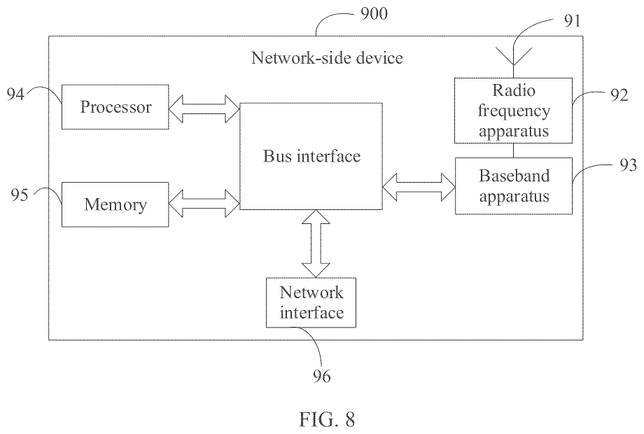

For example, an embodiment of this application further provides a network-side device. As shown in FIG. 8, a network device 900 includes an antenna 91, a radio frequency apparatus 92, and a baseband apparatus 93. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and then sends processed information through the antenna 91.

A frequency band processing apparatus may be located in the baseband apparatus 93. The method performed by the network-side device in the foregoing embodiment may be implemented in the baseband apparatus 93. The baseband apparatus 93 includes a processor 94 and a memory 95.

The baseband apparatus 93 may include, for example, at least one baseband board, and a plurality of chips are disposed on the baseband board. As shown in FIG. 8, one chip is, for example, the processor 94, and is connected to the memory 95, to invoke a program in the memory 95 to perform operations of the network device shown in the foregoing method embodiment.

The baseband apparatus 93 may further include a network interface 96, configured to exchange information with the radio frequency apparatus 92. For example, the interface is a Common Public Radio Interface (CPRI).

For example, the network-side device in this embodiment of the present disclosure further includes an instruction or a program that is stored in the memory 95 and that can be run on the processor 94. The processor 94 invokes the instruction or the program in the memory 95 to perform the method performed by the modules shown in FIG. 4 and achieve same technical effect. To avoid repetition, details are not described herein again.

An embodiment of this application further provides a readable storage medium. A program or an instruction is stored in the readable storage medium. When the program or the instruction is executed by a processor, processes of the method embodiment in FIG. 2 or FIG. 3 are implemented, and same technical effect can be achieved. To avoid repetition, details are not described herein again.

An embodiment of this application further provides a computer program product. The computer program product is stored in a storage medium, and the computer program product is executed by at least one processor to implement processes of the method embodiment in FIG. 2 or FIG. 3 and achieve same technical effect. To avoid repetition, details are not described herein again.

The processor is a processor in the terminal or the network-side device in the foregoing embodiment. The readable storage medium includes a computer-readable storage medium, such as a computer ROM, a Random Access Memory (RAM), a magnetic disk, or an optical disc.

An embodiment of this application further provides a chip. The chip includes a processor and a communication interface. The communication interface is coupled to the processor. The processor is configured to run a program or an instruction of a network-side device to implement processes of the method embodiment in FIG. 2 or FIG. 3 and achieve same technical effect. To avoid repetition, details are not described herein again.

It should be understood that the chip mentioned in this embodiment of this application may also be referred to as a system-level chip, a system chip, a chip system, or a system on chip.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by a statement “includes a . . . ” does not preclude the presence of additional identical elements in the process, method, article, or apparatus that includes the element. In addition, it should be noted that the scope of the method and apparatus in the implementations of this application is not limited to performing functions in an illustrated or discussed sequence, and may further include performing the functions in a basically simultaneous manner or in a reverse sequence based on the functions concerned. For example, the described method may be performed in an order different from the described order, and steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application entirely or the part contributing to the prior art may be implemented in a form of a software product. The computer software product is stored in a storage medium (such as a ROM/RAM, a magnetic disk, or an optical disc), and includes several instructions for instructing a terminal (which may be a mobile phone, a computer, a server, an air conditioner, a network, or the like) to perform the method described in the embodiments of this application.

The embodiments of this application are described above with reference to the accompanying drawings. However, this application is not limited to the foregoing implementations. The foregoing implementations are only illustrative and not restrictive. Under the enlightenment of this application, a person of ordinary skill in the art can make many forms without departing from the purpose of this application and the protection scope of the claims, all of which fall within the protection of this application.

1. A positioning method, comprising:
obtaining, by a first network device, first target information; and
initiating, by the first network device, a positioning procedure based on the first target information, wherein
the positioning procedure comprises at least one of the following:
sending at least one of a Measurement Gap (MG) configuration or MG activation information to a second network device or a terminal;
sending a Positioning Reference Signal (PRS) processing window configuration to the second network device or the terminal; or
sending target indication information to the second network device or the terminal, wherein the target indication information indicates information related to PRS measurement of the terminal.

2. The positioning method according to claim 1, wherein the first target information comprises at least one of the following:
information about a non-serving cell of the terminal, wherein the non-serving cell of the terminal comprises all or some of non-serving cells corresponding to PRSs measured by the terminal;
capability information of the terminal comprising: information used for indicating a threshold range of a receive timing difference between a non-serving cell and a serving cell for supporting PRS processing;
timing difference threshold information; or
indication information sent by the second network device, wherein the indication information indicates whether to determine whether the non-serving cell of the terminal meets a PRS measurement condition.

3. The positioning method according to claim 2, wherein the information about the non-serving cell of the terminal comprises at least one of the following:
time information of the non-serving cell of the terminal;
frequency domain information of the non-serving cell of the terminal; or
identifier information of the non-serving cell of the terminal.

4. The positioning method according to claim 1,
wherein:
the MG configuration is determined by the first network device based on a relationship between a first target PRS to be measured by the terminal and second target information, and first target information,
the MG configuration comprises configuration information for the terminal to use the MG to perform PRS measurement on the first target PRS, and
the second target information comprises at least one of a Subcarrier Spacing (SCS) of a Bandwidth Part (BWP) or a bandwidth relationship.

5. The positioning method according to claim 1, wherein the target indication information indicates a second target PRS, and the second target PRS comprises a PRS of a non-serving cell that is in non-serving cells of the terminal and that does not meet a PRS measurement condition.

6. The positioning method according to claim 1, wherein the target indication information indicates that when the terminal uses an active BWP to perform PRS measurement, the terminal ignores measurement performed on a third target PRS or performs measurement on a fourth target PRS,
wherein the third target PRS comprises a PRS of a non-serving cell that does not meet a PRS measurement condition, or the fourth target PRS comprises a PRS of a non-serving cell that meets a PRS measurement condition.

7. The positioning method according to claim 6,
wherein:
the third target PRS comprises at least one of the following:
a PRS of at least one non-serving cell;
a PRS of at least one Transmission and Reception Point (TRP); or
a PRS of at least one positioning frequency layer;
or
the fourth target PRS comprises at least one of the following:
a PRS of at least one non-serving cell;
a PRS of at least one TRP; or
a PRS of at least one positioning frequency layer.

8. The positioning method according to claim 1, wherein the PRS processing window configuration does not comprise a configuration of a fifth target PRS, or the PRS processing window configuration is not related to a fifth target PRS, wherein the fifth target PRS comprises at least one of the following:
a PRS of at least one non-serving cell;
a PRS of at least one TRP;
a PRS of at least one positioning frequency layer; or
a PRS of a non-serving cell that does not meet a PRS measurement condition.

9. The positioning method according to claim 1, wherein the target indication information indicates at least one of the following: whether the terminal can request an MG, whether the terminal can request a PRS processing window, whether the second network device has requested the MG, whether the second network device has requested the PRS processing window, a manner in which the terminal requests the MG, or a manner in which the terminal requests the PRS processing window.

10. The positioning method according to claim 2, wherein the capability information of the terminal further comprises at least one of the following:
whether to support PRS processing in an active Downlink (DL) BWP;
whether to support PRS processing performed by using an MG;
a processing capability of using the MG to process a PRS;
a processing capability of using the active DL BWP to process the PRS;
whether to support PRS processing performed by using sliding correlation or Fast Fourier Transformation (FFT);
whether to support processing of a PRS of an asynchronous neighboring cell; or
whether to support processing of a PRS of a non-serving cell performed by ignoring a timing difference threshold.

11. The positioning method according to claim 1, wherein the target indication information indicates the terminal to use an active BWP to perform PRS measurement on a premise of at least one of the following assumptions that:
all to-be-measured non-serving cells meet a PRS measurement condition;
all the to-be-measured non-serving cells are synchronized with a serving cell; or
when the terminal supports a sliding window, whether all the to-be-measured non-serving cells meet the PRS measurement condition is ignored, or whether all the to-be-measured non-serving cells are synchronized with the serving cell is ignored.

12. A positioning method, comprising:
sending, by a terminal, first target information to a first network device; and
receiving, by the terminal, at least one of a Measurement Gap (MG) configuration or MG activation information, or receiving a Positioning Reference Signal (PRS) processing window configuration, wherein:
the at least one of the MG configuration or the MG activation information is determined based on the first target information, or
the PRS processing window configuration is determined based on the first target information.

13. The positioning method according to claim 12, wherein the first target information comprises at least one of the following:
capability information of the terminal comprising: information used for indicating a threshold range of a receive timing difference between a non-serving cell and a serving cell for supporting PRS processing;
information about the non-serving cell of the terminal, wherein the non-serving cell of the terminal comprises all or some of non-serving cells corresponding to PRSs measured by the terminal; or
timing difference threshold information.

14. The positioning method according to claim 13, wherein the information about the non-serving cell of the terminal comprises at least one of the following:
time information of the non-serving cell of the terminal;
frequency domain information of the non-serving cell of the terminal; or
identifier information of the non-serving cell of the terminal.

15. The positioning method according to claim 13, further comprising:
when a PRS measurement condition is met, measuring the PRS based on the at least one of the MG configuration or the MG activation information, or the PRS processing window configuration, wherein the PRS measurement condition comprises that a receive timing difference between the non-serving cell of the terminal and the serving cell of the terminal is less than or equal to the threshold range of a receive timing difference indicated by the capability information of the terminal.

16. The positioning method according to claim 12, further comprising:
Sending, by the terminal, an MG request, wherein the MG request is used to request to perform PRS measurement on a first target PRS by using the MG, wherein the first target PRS comprises at least one of the following:
a PRS of at least one non-serving cell;
a PRS of at least one TRP;
a PRS of at least one positioning frequency layer;
the PRS of the non-serving cell that does not meet the PRS measurement condition; or
a PRS that does not match a current active BWP of the terminal.

17. A network device, comprising: a processor; and a memory having a program or an instruction stored therein, wherein the program or the instruction, when executed by the processor, causes the processor to perform operations comprising:
obtaining first target information; and
initiating a positioning procedure based on the first target information,
wherein the positioning procedure comprises at least one of the following:
sending at least one of a Measurement Gap (MG) configuration or MG activation information to a second network device or a terminal;
sending a Positioning Reference Signal (PRS) processing window configuration to the second network device or the terminal; or
sending target indication information to the second network device or the terminal, wherein the target indication information indicates information related to PRS measurement of the terminal.

18. The network device according to claim 17, wherein the first target information comprises at least one of the following:
information about a non-serving cell of the terminal, wherein the non-serving cell of the terminal comprises all or some of non-serving cells corresponding to PRSs measured by the terminal;
capability information of the terminal comprising: information used for indicating a threshold range of a receive timing difference between a non-serving cell and a serving cell for supporting PRS processing;
timing difference threshold information; or
indication information sent by the second network device, wherein the indication information indicates whether to determine whether the non-serving cell of the terminal meets a PRS measurement condition.

19. The network device according to claim 18, wherein the capability information of the terminal further comprises at least one of the following:
whether to support PRS processing in an active Downlink (DL) BWP;
whether to support PRS processing performed by using an MG;
a processing capability of using the MG to process a PRS;
a processing capability of using the active DL BWP to process the PRS;
whether to support PRS processing performed by using sliding correlation or Fast Fourier Transformation (FFT);
whether to support processing of a PRS of an asynchronous neighboring cell; or
whether to support processing of a PRS of a non-serving cell performed by ignoring a timing difference threshold.

20. A terminal, comprising: a processor; and a memory having a program or an instruction stored therein, wherein the program or the instruction, when executed by the processor, causes the processor to perform steps of the positioning method according claim 12.
